(19) United States
(12) Patent Application Publication
(10) Pub. No.: US 2012/0242682 A1
(43) Pub. Date: Sep. 27, 2012

(54) APPARATUS AND METHOD FOR DISPLAYING IMAGE

(75) Inventor: Takafumi NANJO, Sagamihar-shi (JP)

(73) Assignee: KONICA MINOLTA MEDICAL & GRAPHIC, INC., Tokyo (JP)

(21) Appl. No.: 13/425,766

(22) Filed: Mar. 21, 2012

(30) Foreign Application Priority Data
Mar. 22, 2011 (JP) 2011-061889

(51) Int. Cl. G09G 5/02

(52) U.S. Cl. 345/601

(57) ABSTRACT

An image display apparatus includes a display unit; a determination unit to determine, based on a predetermined condition, whether or not a conversion process for converting image data from monochrome to color is to be executed to image data of a monochrome medical image; and a display controller to execute the conversion process to the image data, when the determination unit determines execution of the conversion process, to display a colored medical image on the display unit based on processed image data obtained through the conversion process.

### BACKGROUND OF THE INVENTION

1. Field of the Invention

The present invention relates to an apparatus and a method for displaying an image.

2. Description of Related Art

In recent years, medical images photographed by a modality such as computed radiography (CR), computed tomography (CT), magnetic resonance (MR), and the like, have been stored in an image server in the form of digital images, as picture archiving and communication system (PACS) has come into wide use.

However, medical doctors accustomed to interpreting a medical image formed on a film are frequently complicated due to the difference of a color tone between a film image and a digital image. Therefore such medical doctors have desired a method of displaying a medical image with a color tone similar to a color tone of a medical image on the film.

Accordingly, a proposed image display apparatus includes a color look up table (LUT) for converting monochrome image data to color image data to display a colored medical image on a monitor (see Japanese Patent Application Laid Open Publication No. 2008-168044). For example, a color LUT that adds a slightly blue tone to an image can be used to provide image quality similar to a color tone of an image on the film.

However, when a colored digital image is formed from a monochrome image with applying a color LUT, memory usage and processing time per image unfavorably increases compared to generating an image without applying a color LUT, i.e. generating a monochrome image. Such increase of memory usage and processing time is particularly disadvantageous for processing of a large number of images, such as processing using CT or MR.

For example, 8-bit bitmap data of a monochrome image is converted by applying of the color LUT to 24-bit bitmap data of a color image having colors of RGB (Red, Green and Blue). That is, applying a color LUT requires a large size of memory. Therefore, when reading a lot of color image data, the increase of a memory size per image causes eviction of color image data from a memory area. In such a case, it leads low performance of image processing because color image data is retrieved when using the data. In particular, in the case of display of medical images for circulatory organs, the images must be changed one after another at a constant speed such as 30 fps (frame per second). Thus, in such a case, the eviction of color image data from a memory area causes delay of image data processing.

A conversion process of image data with referring various LUTs is executed after loading image data into a memory. When referring a color LUT, the conversion process takes time about three times longer than without referring a color LUT.

In addition, some kinds of medical images are not required to be colorized. Thus in such a case, it is not adequate to apply a color LUT to a monochrome medical image because it consumes the amount of memory and processing time.

### SUMMARY OF THE INVENTION

The present invention has been made in consideration for the foregoing problem inherent in the related art, and an object of the present invention is to improve the efficiency of a conversion process for converting image data from monochrome to color.

In order to accomplish the above object, in accordance with a first aspect of the present invention, there is provided an image display apparatus, including: a determination unit to determine, based on a predetermined condition, whether or not a conversion process for converting image data from monochrome to color is to be executed to image data of a monochrome medical image; and a display controller to execute the conversion process to the image data, when the determination unit determines execution of the conversion process, to display a colored medical image on the display unit based on processed image data obtained through the conversion process.

In accordance with the first aspect of the present invention, the conversion process for converting image data from monochrome to color will be executed efficiently.

Preferably, the determination unit of the image display apparatus determines whether or not to execute the conversion process based on whether or not a modality for generating the image data of the monochrome medical image is a predetermined modality.

According to an embodiment of the present invention, as determining whether or not to execute the conversion process for converting image data from monochrome to color based on a kind of modality, the conversion process for converting image data from monochrome to color will be executed efficiently.

Preferably, the determination unit of the image display apparatus determines whether or not to execute the conversion process based on whether or not the number of separated display areas of a monitor of the display unit is equal to or less than a predetermined value.

According to an embodiment of the present invention, as determining whether or not to execute the conversion process for converting image data from monochrome to color based on the number of separated display areas of a monitor of the display unit, the conversion process for converting image data from monochrome to color will be executed efficiently.

Preferably, the determination unit of the image display apparatus determines whether or not to execute the conversion process based on whether or not the number of data generated in the same study as for the image data of the monochrome medical image is equal to or less than a predetermined value.

According to an embodiment of the present invention, as determining whether or not to execute the conversion process for converting image data from monochrome to color based on the number of image data generated in the same study as for the image data of the monochrome medical image, the conversion process for converting image data from monochrome to color will be executed efficiently.

In accordance with a second aspect of the invention, there is provided a method for displaying an image, including the steps of; determining whether or not a conversion process for converting image data from monochrome to color is to be executed to image data of a monochrome medical image based on a predetermined condition; and executing the conversion process when the conversion process is determined to be executed in the determination step, and displaying a colored medical image on a display unit based on a processed image data obtained through the conversion process.

In accordance with the second aspect of the present invention, the conversion process for converting image data from monochrome to color will be executed efficiently.

### BRIEF DESCRIPTION OF THE DRAWINGS

The present invention will become more fully understood from the detailed description given hereinbelow and the appended drawings, and thus are not intended as a definition of the limits of the present invention, and wherein:

FIG. 1 is a system configuration of a medical image display system according to an embodiment of the present invention;

FIG. 2 is a block diagram showing a functional configuration of an image sever according to an embodiment of the present invention;

FIG. 3 is a block diagram showing a functional configuration of a client terminal according to an embodiment of the present invention;

FIG. 4 is a view showing two examples of a conversion process applying a color LUT and a conversion process without applying a color LUT;

FIG. 5 is a flowchart showing a first medical image display process executed by the client terminal;

FIG. 6 is a flowchart showing a second medical image display process executed by the client terminal; and

FIG. 7 is a flowchart showing a third medical image display process executed by the client terminal.

### DETAILED DESCRIPTION OF PREFERRED EMBODIMENT

### First Embodiment

A first embodiment of the present invention is described below.

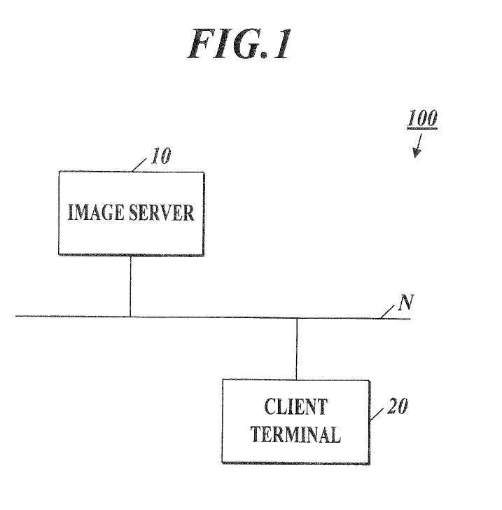

FIG. 1 shows a system configuration of a medical image display system 100. As shown in FIG. 1, the medical image display system 100 includes an image sever 10 and a client terminal 20 that functions as an image display apparatus. The image server 10 and the client terminal 20 are connected to each other through a network N such as a Local Area Network (LAN) to transmit and receive data therebetween. The network N is compliant with the digital imaging and communications in medicine (DICOM) standard.

The image server 10, adopting PACS, and stores image data files of medical images (hereinafter referred to as “image files”) generated by modalities, and provides image files or the like in response to requests from an external device such as the client terminal 20.

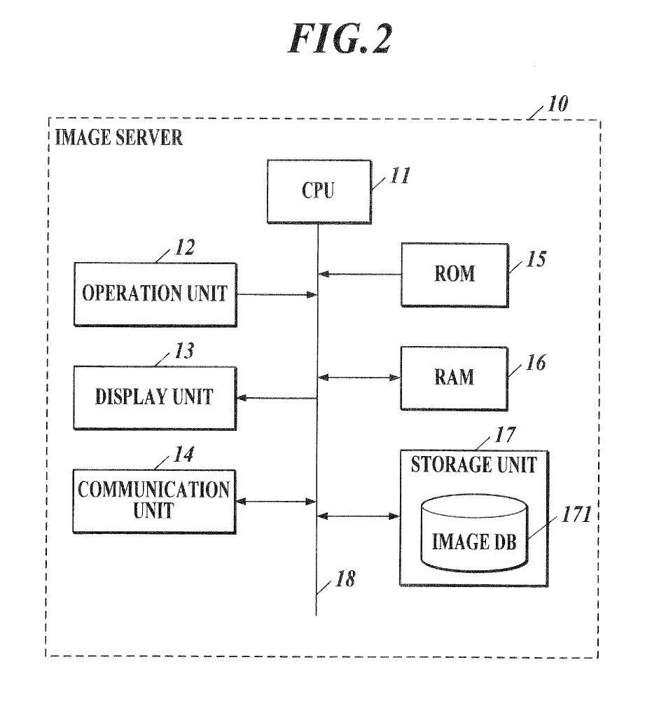

FIG. 2 shows a functional configuration of the image server 10. As shown in FIG. 2, the image server 10 includes a central processing unit (CPU) 11, a operation unit 12, a display unit 13, a communication unit 14, a read only memory (ROM) 15, a random access memory (RAM) 16, and a storage unit 17, which are connected to each other by a bus 18.

The CPU 11 controls operations of each component of the image server 10 in a centralized manner. Specifically, the CPU 11 reads out various processing programs stored in the RAM 15 in response to an operation signal input from the operation unit 12 or an instruction signal received by the communication unit 14, and expands the processing programs stored in the ROM 15 into a work area created in the RAM 16, and then executes a variety of processes in cooperation with the processing programs.

The operation unit 12 includes a keyboard including such as cursor keys, numeric keys, a variety of functional keys, and a pointing device such as a mouse, and outputs an operation signal, which is input through key operation on the keyboard or mouse operation, to the CPU 11.

The display unit 13 includes a liquid crystal display (LCD), and displays images based on display data input from the CPU 11.

The communication unit 14 corresponds to an interface which transmits and receives data between the image server 10 and an external device such as the client terminal 20.

The ROM 15 is composed of a non-volatile semiconductor memory, or the like, and stores control programs and parameters or files that are necessary to execute the control programs.

The RAM 16 creates a work area for temporarily storing programs, input data or output data, and parameters that are read out from the ROM 15, and the like, at various processes the execution of which is controlled by the CPU 11.

The storage unit 17 is composed of a hard disk or the like and stores various data. Specifically, the storage unit 17 stores an image database (image DB) 171. The image DB 171 stores a plurality of image files. Each image file includes image data and supplementary information of the medical image.

The supplementary information includes patient information, study information, series information and image information. The patient information includes a variety of information related to a patient such as patient ID, patient name, sex, birth date, age, height, and weight. The study information includes a variety of information related to a study such as Study Instance UID for identifying each study, study date, study time, receipt number, and name of doctor-in-charge. The series information includes a variety of information related to a set of medical images generated in a single study of each modality (referred to as “series”), such as Series Instance UID for identifying each study, modality (a kind of study), study site, and series number. The image information includes a variety of information related to a medical image such as SOP instance UID for identifying each image, image number, file path of the medical image, size of the medical image, LUT information (modality LUT and value-of-interest (VOI) LUT).

The modality LUT normalizes image data having values specific to each kind of modality. The VOI LUT converts values of image data into values suitable for displaying.

The CPU 11 reads out the requested image file from the image DB 171 of the storage unit 17 when the CPU 11 receives an acquisition request of the image file from the client terminal 20, and transmits the requested image file to the client terminal 20.

The client terminal 20 is an apparatus for displaying the medical image based on the image file obtained from the image server 10 to execute an interpretation of the medical image, and is composed of a personal computer (PC) or the like.

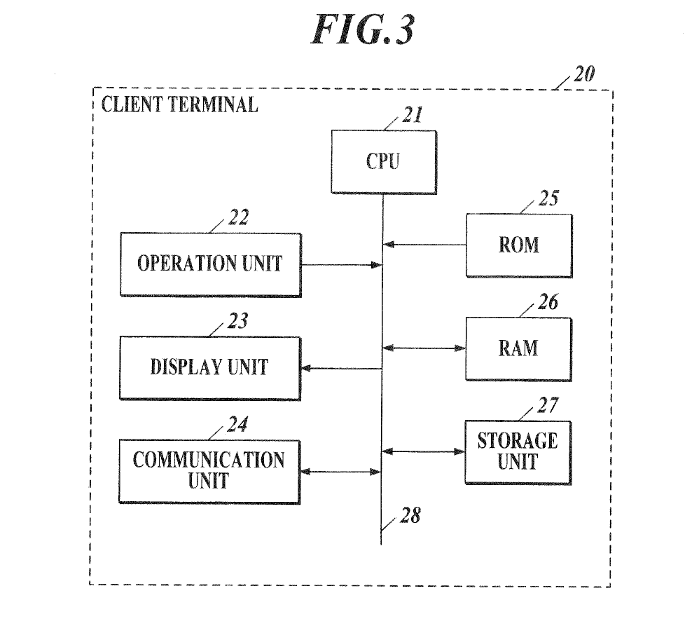

FIG. 3 shows a functional configuration of the client terminal 20. As shown in FIG. 3, the client terminal 20 includes a CPU 21, an operation unit 22, a display unit 23, a communication unit 24, a ROM 25, a RAM 26, and a storage unit 27, which are connected to each other through a bus 18.

The CPU 21 controls operations of each component of the client terminal 20 in a centralized manner. Specifically, the CPU 21 reads out various processing programs stored in the ROM 25 in response to an operation signal input from the operation unit 22 or an instruction signal received by the communication unit 24, expands the processing programs into a work area created in the RAM 26, and then executes various processes in cooperation with the processing programs.

The operation unit 22 is a functional unit which receives operation instructions from users. The operation unit 22 includes a keyboard including such as cursor keys, numeric keys, a variety of function keys and a pointing device such as a mouse, and outputs operation signals that are input through operating a keyboard or a mouse, to the CPU 11.

The display unit 23 is a high-resolution monitor composed of an LCD, and displays various images based on data input by the CPU 21. For example, the display unit 23 displays a medical image to be interpreted.

The communication unit 24 corresponds to an interface which transmits and receives data between the client terminal 20 and an external device such as the image server 10.

The ROM 25 is composed of a non-volatile semiconductor memory, or the like, and stores control programs and parameters or files that are necessary to execute the control programs.

The RAM 26 creates a work area for temporarily storing various programs, input data or output data, and parameters read out from the ROM 25, and the like, at various processes the execution of which is controlled by the CPU 11. Specifically, the RAM 26 stores image files or the like obtained from the image server 10.

The storage unit 27 is composed of a hard disk or the like and stores a variety of data.

The CPU 21 transmits an acquisition request of the image file stored in the storage unit 17 to the image server 10 via the communication unit 24, and receives the requested image file from the image server 10.

The CPU 21 determines whether or not a conversion process for converting image data from monochrome to color is to be executed to image data of a monochrome medical image obtained from the image server 10 (hereinafter referred to as “a color LUT process”) based on a predetermined condition. That is, the CPU 21 functions as a determination unit.

Specifically, the CPU 21 refers supplementary information included in the image file obtained from the image server 10, and obtains information of a kind of modality which generates the medical image data. Then the CPU 21 determines whether or not to execute the color LUT process based on whether or not the modality which generates the image data of the monochrome medical image is a predetermined modality. For example, the CPU 21 does not execute the color LUT process when a modality concerned is CT or MR, and executes the color LUT process when a modality concerned is other than CT or MR (CR or the like).

The color LUT process with applying the color LUT converts monochrome (gray scale) image data to color image data representing R (Red), G (Green), and B (Blue) that are the output colors of the display unit 23. For example, the color LUT process converts monochrome image data to color image data representing a color shade of slightly bluish gray that is similar to a medical image output onto a film.

The CPU 21 executes the color LUT process for converting image data from monochrome to color and displays a colored medical image on the display unit 23 based on the processed image data obtained through the color LUT process when the CPU determines to execute the color LUT process. That is, the CPU 21 functions as a display controller.

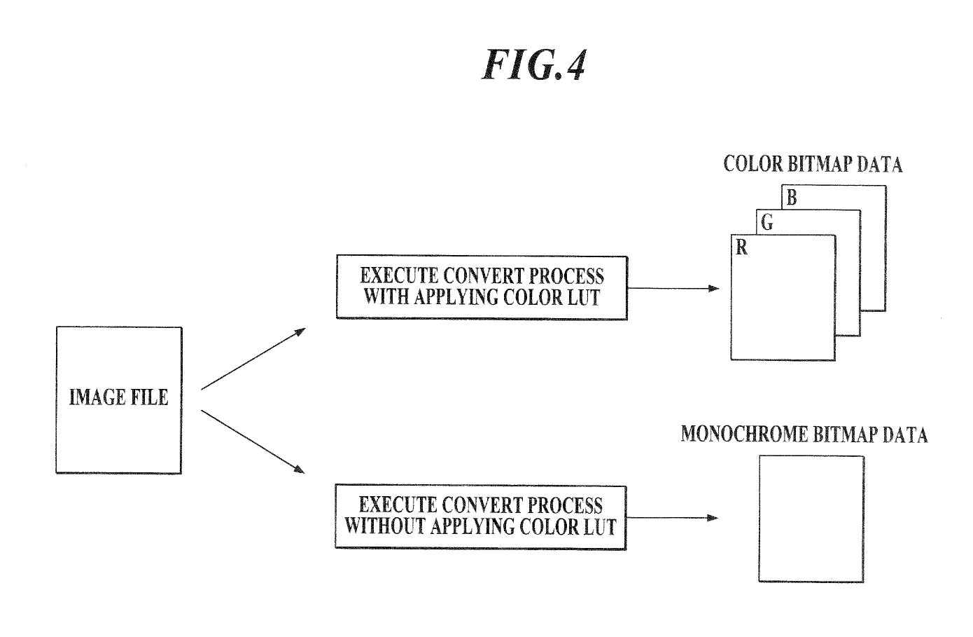

As shown in FIG. 4, the CPU 21 executes the color LUT process when a predetermined condition is satisfied, and generates a RGB bitmap data. In this case, LUTs which the conversion process applies include the modality LUT, the VOI LUT, and the color LUT.

On the other hand, when a predetermined condition is not satisfied, the CPU 21 executes a conversion process without applying the color LUT, and generates a monochrome bitmap data. In this case, the conversion process applies the modality LUT and the VOI LUT, but does not apply the color LUT.

Next, the operation of the system is described.

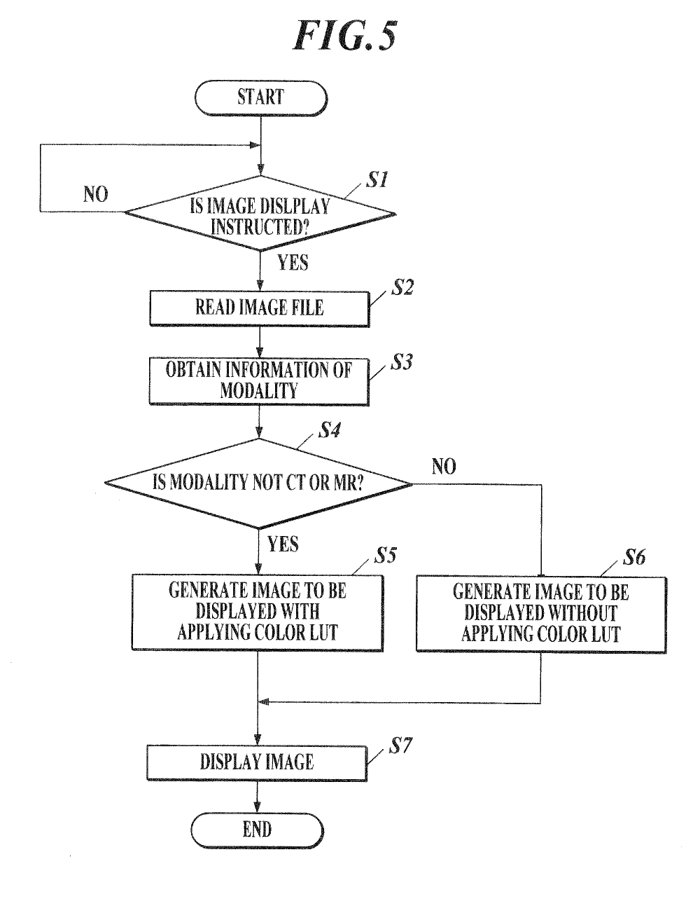

FIG. 5 is a flowchart showing a medical image display process of the first embodiment executed by the client terminal 20. This process is implemented by software processing executed by the CPU 21 in cooperation with programs stored the ROM 25.

The CPU 21 receives an instruction signal to display an image input by a user from the operation unit 23 (Step S1; YES), retrieves an image file from the image server 10 through the communication unit 24, and then loads the image file into the RAM 26 (Step S2). Specifically, the CPU 21 transmits an acquisition request of the image file of the medical image to be interpreted to the image server 10 through the communication unit 24.

Next, the CPU 21 obtains information of a kind of modality included in the supplementary information of the image file (Step S3), and judges whether or not a modality generating the image data is other than CT or MR (Step S4).

When the relevant modality is a modality other than CT or MR (Step S4; YES), the CPU executes the color LUT process for converting image data from monochrome to color with applying the color LUT, and generates a colored image to be displayed (24-bit color bitmap data) (Step S5).

On the other hand, when the relevant modality is CT or MR (Step S4; NO), the CPU executes the color LUT process for converting image data from monochrome to color without applying the color LUT, and generates a monochrome image to be displayed (8-bit monochrome bitmap data) (Step S6).

After Step S5 or S6, the CPU 21 displays a medical image on the display unit 23 based on color bitmap data or monochrome bitmap data (Step S7).

Then whole process of the first embodiment of the invention is completed.

As described above, the client terminal 20 of the medical image display system 100 determines whether or not to execute the color LUT process based on a kind of modality which generates image data, so that the color LUT process will be executed efficiently.

Heretofore, a medical image generated by CR has been formed on a film. Thus, when using CR, doctors often require an image quality of a digital image to be similar to the image quality of a film image. According to the first embodiment of the present invention, when a modality which generates a medical image is CR (i.e. other than CT or MR), or the like, the color LUT process provides a colored digital image similar to a film image.

In the case where a large number of images are processed, for example, in CT or MR, the processing speed is often put ahead the adjustment of a color tone. Thus, according to the first embodiment of the present invention, the color LUT process is not executed, so that memory usage and processing time will be reduced when the relevant modality is CT or MR.

As described above, whether or not to execute the color LUT process is determined automatically, so that users do not need to determine whether or not to execute the color LUT process for every image. Thus improvement of operability will be achieved.

In addition, image quality is optimized and memory usage is reduced depending on a kind of modality, so that efficiency improvement of image interpretation will be achieved.

### Second Embodiment

Next, a second embodiment of the present invention is described below.

A medical image display system of the second embodiment includes the same configuration as that of the medical image display system 100 shown in the first embodiment, and thus descriptions and illustration of a configuration of the second embodiment are omitted. The configuration and process characteristic to the second embodiment is described below with reference to FIGS. 1 to 3.

The second embodiment is the same as the first embodiment except for the conditions for determination on the color LUT process.

The storage unit 27 stores display setting information referred for displaying an image on the display unit 23. The display setting information includes such as the number of separated display areas of a monitor of the display unit 23 (the number of frames in a single monitor; hereinafter referred to as “the number of frames”), top-left coordinates of a region for displaying an image to be interpreted, and sizes of each display area (the numbers of pixels constituting each display area in lateral and longitudinal directions). The number of frames refers to the number of separated display areas of a medical image for displaying images in each of lateral and longitudinal directions, and is represented by, for example, (lateral direction)×2 (longitudinal direction). The display setting information can be changed through user operations input at the operation unit 12.

The CPU 21 obtains information of the number of frames for displaying the medical image on the display unit 23 included in the display setting information stored in the storage unit 27.

The CPU 21 determines whether or not to execute the color LUT process based on whether or not the number of frames is equal to or less than a predetermined value. For instance, the CPU 21 executes the color LUT process when the number of frames is 1×1, while does not execute the color LUT process when the number of frames is other than 1×1.

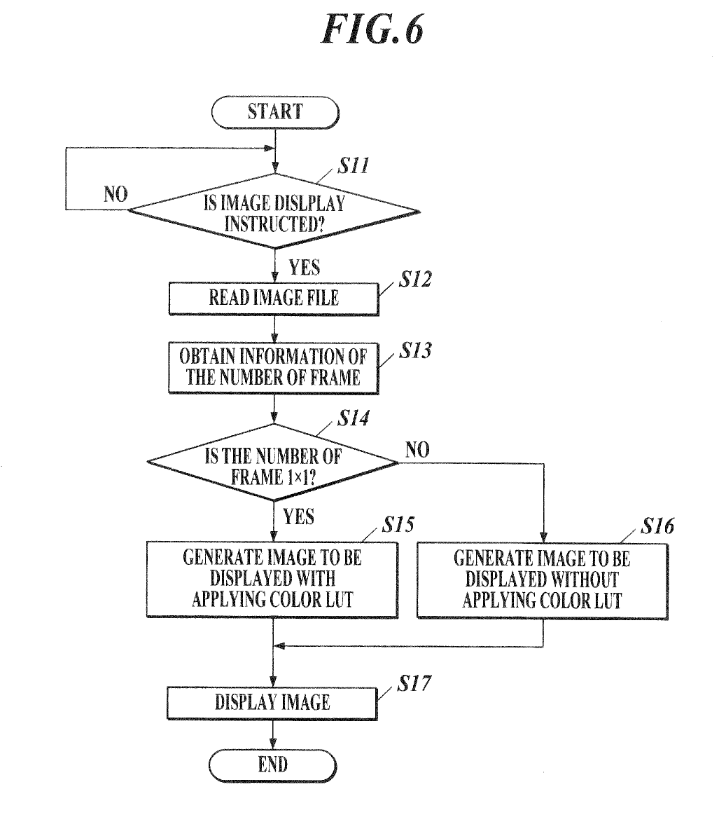

FIG. 6 is a flowchart showing a medical display process of the second embodiment executed by the client terminal 20. This process is implemented by software processing executed by the CPU 21 in cooperation with programs stored the ROM 25.

The respective processes of steps S11 and S12 are the same as those of steps S1 and S2 shown in FIG. 5, thus descriptions of steps S11 and S12 are omitted.

Next, the CPU 21 obtains information of the number of frames for displaying a medical image on the display unit 23 from the display setting information stored in the storage unit 27 (Step S13), and then judges whether the number of frames is 1×1 or not (Step S14).

When the number of frames is 1×1 (Step S14; YES), the CPU 21 executes the color LUT process (a conversion process for converting medical image data from monochrome to color with referring the color LUT) and generates a colored image to be displayed (24-bit color bitmap data) (Step S15).

When the number of frames is not 1×1 (Step S14; NO), the CPU execute a conversion process without referring the color LUT, and generates a monochrome image to be displayed (8-bit monochrome bitmap data) (Step S16).

After step S15 or S16, the CPU 21 displays the medical image on the display unit 23 based on color bitmap data or monochrome bitmap data (Step S17).

Then whole process of the second embodiment of the invention is completed.

As described above, the client terminal 20 of the second embodiment of the invention determines whether or not to execute the color LUT process based on the number of frames of the display unit 23, so that the color LUT process will be executed efficiently.

For example, when the number of frames of the display unit 23 is 1×1, careful interpretation is often required under conditions similar to those in the case of using the film. According to the second embodiment of the present invention, when the number of frames is equal to or less than a predetermined value (for example, 1×1), the color LUT process is executed, so that a colored digital image with a film-like tone will be provided.

On the other hand, when the number of frames of the display unit 23 is larger than a predetermined value, the color LUT process is not executed, so that memory usage and processing time will be reduced.

As described above, whether or not to execute the color LUT process is determined automatically, so users do not need to instruct whether or not to execute the color LUT process. Thus improvement of operability will be achieved.

In addition, image quality is optimized and memory usage is reduced depending on the number of frames, so that efficiency improvement of image interpretation will be achieved.

### Third Embodiment

Next, a third embodiment of the present invention is described below.

A medical-image display system of the third embodiment has the same configuration as that of the medical-image display system 100 of the first embodiment, and thus description and illustration of the configuration are omitted. The configuration and process characteristic to the third embodiment is described below with reference to FIGS. 1 to 3.

The third embodiment is the same as the first or second embodiment except for the conditions for determination on the color LUT process.

The CPU 21 obtains information of the number of image data generated with a monochrome medical image to be displayed in the same (a single) study. Specifically, the CPU 21 refers a series instance UID included in supplementary information in the image file obtained from the image server 10, and transmits an acquisition request of information of the number of the image data (the image files) having the same series instance UID to the image server 10, and receives the information of the number of the image data generated in a single study from the image server 10.

The CPU 21 determines whether or not to execute the conversion process based on whether or not the number of image data generated in the same study as for the image data of the monochrome medical image is equal to or less than a predetermined value. For instance, the CPU 21 executes the color LUT process when the number of the images is 99 or less, and does not execute the color LUT process when the number of the images is 100 or more.

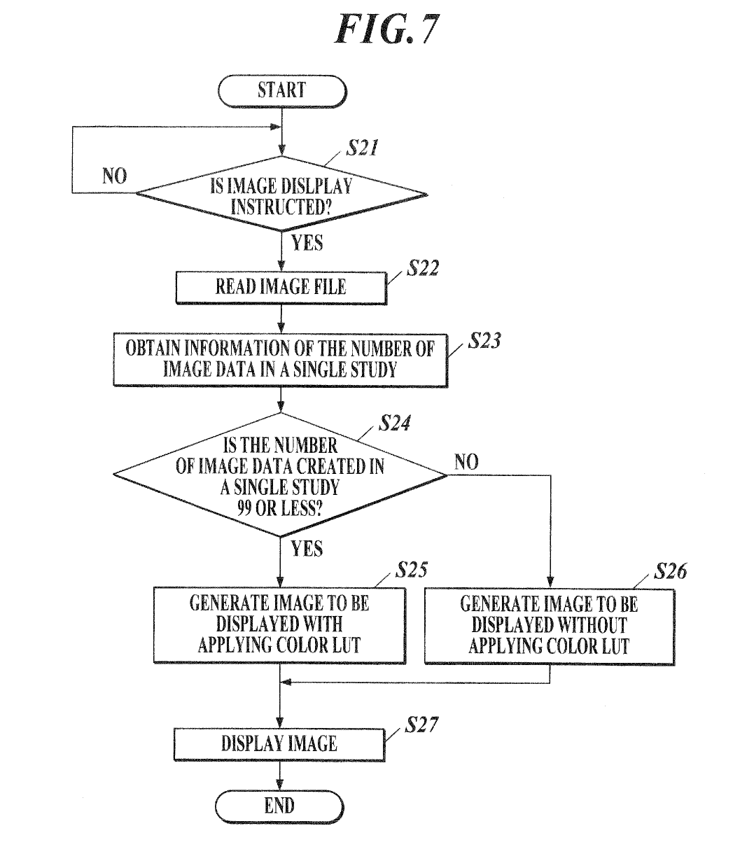

FIG. 7 is a flowchart showing a medical image display process of the third embodiment executed by the client terminal 20. This process is implemented by software processing executed by the CPU 21 in cooperation with programs stored the ROM 25.

The respective processes of steps S11 and S12 are the same as those of steps S1 and S2 shown in FIG. 5, thus descriptions of steps S11 and S12 are omitted.

Next, the CPU 21 obtains information of the number of the images generated with a monochrome medical image to be displayed in the same study from the image server 10 (Step S23). Specifically, the CPU 21 refers a series instance UID included in supplementary information of the image file, transmits an acquisition request of the information of the number of image data (image files) having the same instance UID to the image server 10, and then obtains information of the number of the image data generated with a monochrome medical image to be displayed in the same study from the image server 10.

Next, the CPU 21 judges whether or not the number of the image data generated in the same study as for the image data of the monochrome medical image is equal to or less than 99 (Step S24).

When the number of the image data is 99 or less (Step S24; YES), the CPU 21 executes the color LUT process, and generates a colored image to be displayed (24-bit color bitmap data) (Step S25).

On the other hand, when the number of the image data is equal to 100 or more (Step S24; NO), the CPU 21 executes the conversion process without referring the color LUT, and generates a monochrome image to be displayed (8-bit monochrome bitmap data) (Step S26).

After Step 25 or 26, the CPU displays an image based on a color bitmap data or a monochrome bitmap data on the display unit 23 (Step S27).

Then whole process of the third embodiment of the invention is completed.

As described above, the client terminal 20 of the third embodiment of the invention determines whether or not to execute the color LUT process based on the number of image data generated in the same study as for the image data of the monochrome medical image. Thus the color LUT process will be executed efficiently.

When the number of image data is equal to or less than a predetermined value, careful interpretation is often required under conditions similar to those in the case of using the film. According to the third embodiment of the present invention, when the number of image data is equal to or less than a predetermined value, the color LUT process is executed, so that a colored digital image with a film-like tone will be provided.

On the other hand, when the number of image data is larger than the predetermined value, the processing speed is often put ahead the adjustment of a color tone. Therefore, the color LUT process is not executed, so that memory usage and processing time will be reduced.

As described above, whether or not to execute the color LUT process is determined automatically, users do not need to instruct whether or not to execute the color LUT process. Thus improvement of operability will be achieved.

In addition, image quality is optimized and memory usage is reduced depending on the number of image data generated in the same study, so that efficiency improvement of image interpretation will be achieved.

Note that the descriptions above are merely the examples of the image display apparatus of the invention thus are not intended as a definition of the limits of the present invention. It is also possible to appropriately modify detailed configurations and operations of the respective units configuring the apparatus within the scope without departing from the spirit of the invention.

For example, the determination conditions for determining whether the color LUT process is to be performed or not are not limited to the exemplary conditions in the above-described embodiments. The modality types, the threshold value of the number of separated display area of the monitor (the number of frames), and the threshold value of the number of image data created in the same study can be changed according to user instruction.

In the foregoing descriptions, the ROM is described as an example of a recording medium that is readable by computer storing programs for executing processes, though this is not limitative. For example, a removable media such as a non-volatile semiconductor memory like a flash memory or a CD-ROM can be applied. Moreover, as a media for providing data of programs through a communication line, career waves can be applied.

According to one aspect of preferred embodiment of the invention, there is provided a client terminal 20 including: the CPU 21 determining whether or not to execute a conversion process for converting image data from monochrome to color is to be executed to image data of a monochrome medical image; and The CPU 21 executing the conversion process when the CPU 21 determines to execute the conversion process to display a colored medical image on the display unit 13 based on processed image data obtained through the conversion process.

The client terminal 20 makes the conversion process from monochrome to color more efficient.

Preferably, in the client terminal 20, the CPU 21 determines whether or not to execute the conversion process based on whether or not a modality for generating the image data of the monochrome medical image is a predetermined modality.

The client terminal 20 determines whether or not to execute the conversion process based on a kind of modality, so that the conversion process from monochrome to color is executed efficiently.

Preferably, in the client terminal 20, the CPU 21 determines whether or not to execute the conversion process based on whether or not the number of separated display areas of a monitor of the display unit 13 (the number of frames) is equal to or less than a predetermined value.

The client terminal 20 determines whether or not to execute the conversion process based on the number of frames, so that the conversion process from monochrome to color will be executed efficiently.

Preferably, in the client terminal 20, the CPU 21 determines whether or not to execute the conversion process based on whether or not the number of image data generated in the same study as for the image data of the monochrome medical image is equal to or less than a predetermined value.

The image display apparatus determines whether executes the conversion process from monochrome to color based on the number of image data generated in the same study as for the image data of the monochrome medical image, so that the conversion process from monochrome to color is executes efficiently.

According to another aspect of a preferred embodiment of the invention, a method for displaying an image will be provided, which includes the steps of: determining whether or not a conversion process for converting image data from monochrome to color is to be executed to image data of a monochrome medical image; and executing the conversion process when the conversion process is determined to be executed, in the determination step, and displaying a colored medical image based on the processed image data obtained through the conversion process.

The display method makes the conversion process from monochrome to color more efficient.

The entire disclosure of Japanese Patent Application No. 2011-061889 filed on Mar. 22, 2011 is incorporated herein by reference in its entirety.

What is claimed is:

1. An image display apparatus comprising:
a display unit;
a determination unit to determine, based on a predetermined condition, whether or not a conversion process for converting image data from monochrome to color is to be executed to image data of a monochrome medical image; and
a display controller to execute the conversion process to the image data, when the determination unit determines execution of the conversion process, to display a colored medical image on the display unit based on processed image data obtained through the conversion process.

2. The image display apparatus according to claim 1,
wherein the determination unit determines whether or not to execute the conversion process based on whether or not a modality for generating the image data of the monochrome medical image is a predetermined modality.

3. The image display apparatus according to claim 1,
wherein the determination unit determines whether or not to execute the conversion process based on whether or not the number of separated display areas of a monitor of the display unit is equal to or less than a predetermined value.

4. The image display apparatus according to claim 1,
wherein the determination unit determines whether or not to execute the conversion process based on whether or not the number of image data generated in the same study as for the image data of the monochrome medical image is equal to or less than a predetermined value.

5. A method for displaying an image, comprising the steps of:
determining whether or not a conversion process for converting image data from monochrome to color is to be executed to image data of a monochrome medical image; and
executing the conversion process when the conversion process is determined to be executed in the determination step, and displaying a colored medical image on a display unit based on processed image data obtained through the conversion process.
